(19) United States
(12) Patent Application Publication
(10) Pub. No.: US 2008/0297145 A1
(43) Pub. Date: Dec. 4, 2008

(54) Increasing the working gap in a magnetic sensor with an auxiliary field

(75) Inventors: Dietmar Mahr, Feldkirch (AT); Werner Dengler, Nuziders (AT)

Correspondence Address: K.F. ROSS P.C., 5683 RIVERDALE AVENUE, SUITE 203 BOX 900, BRONX, NY, 10471-0900, US

(73) Assignee: Hirschmann Automotive GmbH

(21) Appl. No.: 11/810,136

(22) Filed: Jun. 4, 2007

(30) Foreign Application Priority Data
Jun. 3, 2007 (DE) 102006026110.0

(51) Int. Cl. G01B 7/14; G01B 7/30

(52) U.S. Cl. 324/207.13

(57) ABSTRACT

The invention relates to a sensor system (1) having a sensor magnet (2) and a magnetosensitive sensor (3) associated therewith, a sensed object (5) being located and movable near the magnetosensitive sensor (3), and according to the invention an additional magnet (4) is spaced from the sensor magnet (2) and the sensed object is movably positioned between the two magnets (2 and 4).

The invention relates to a sensor system based on the magnetosensitive principle, according to the features of the preamble of claim 1.

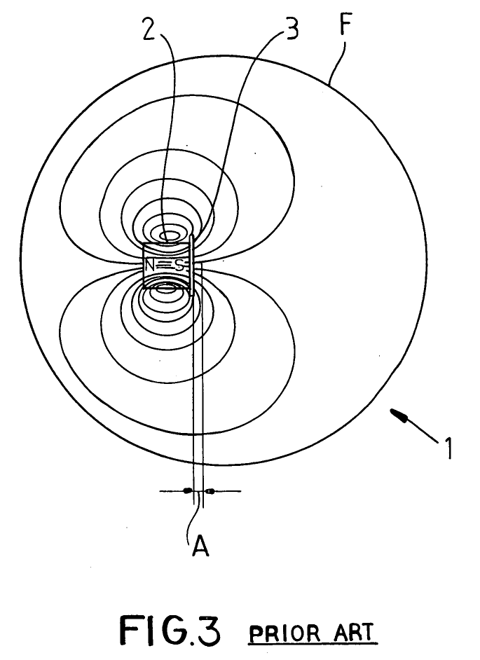

A sensor system based on the magnetosensitive principle, as shown in FIG. 3 as an example and described below, is basically known. This sensor system 1 has a sensor magnet 2 and an associated magnetosensitive sensor 3 (a Hall sensor, for example). Starting from the north pole N, field lines F extend from the sensor magnet 2 toward the south pole S. To achieve the desired function with this sensor system, the sensed object (not illustrated here) must pass near of the sensor magnet 2 or the magnetosensitive sensor 3. This results in a limited functional region of the sensor system 3 with regard to the working gap, which typically is less than 5 mm. This is due to the fact that intense scattering of the magnetic field lines F occurs as a function of the spatial dimensions of the sensor magnet 2 and the resulting curves of the field lines F. In other words, at spacings between the sensor magnet 2 and the sensed object that are greater than referenced above, only a low magnetic flux density is present in the surface region of the sensed object made of a magnetic material, and movement of the sensed object therefore results in only slight field changes, for which the magnetosensitive sensor 3 has little or no capability for detection. In turn, this means that the sensitivity of the sensor system 1, in particular the magnetosensitive sensor, 3, is no longer sufficient to detect these minimal field changes at greater working gaps (in particular at spacings greater than 5 mm).

To increase the sensitivity of such a sensor system, the magnetic and/or spatial characteristics of the sensor magnet 2 could be augmented in order to generate stronger field lines at greater spacings from the sensor magnet 2. However, this has the disadvantage that often there is not room to increase the size of the sensor magnet, thereby precluding this means of improvement. To generate stronger field lines while maintaining the same dimensions, it is necessary to use specialized magnetic materials that, however, have the disadvantage that they are costly and/or are problematic in the manufacture of such sensor systems.

The object of the invention, therefore, is to provide a sensor system in which the functional region of the sensor system is improved with respect to the working gap; i.e. the aim is to be able to pass a sensed object at greater spacings from the sensor magnet or the magnetosensitive sensor than have been known heretofore.

This object is achieved by the features of claim 1.

According to the invention, an additional magnet (also referred to as a helper magnet) is provided at a spacing from the sensor magnet, and the sensed object is movably positioned between the two magnets. The helper magnet has the effect that the field lines between the two magnets are concentrated more strongly in a specified (desired) direction (preferred direction). This allows the sensed object to be positioned and moved at a greater spacing from the sensor magnet than possible heretofore, since in this case at the greater spacing between the sensor magnet or the magnetosensitive sensor and the sensed object a sufficiently high magnetic flux density is present in the surface region of the sensed object, resulting in the high field change during movement of the sensed object that is necessary for detecting movement of the sensed object. The sensitivity of the sensor system is thus advantageously increased by providing this helper magnet at a spacing from the sensor magnet, since the magnetic field lines between the respective poles of the magnets are aligned (concentrated) in the preferred direction, so that the disadvantageous intense scattering of the magnetic field lines no longer occurs.

In one refinement of the invention, the sensed object is situated at a spacing from the sensor magnet that is greater than the spacing from the helper magnet. In other words, the spacing between the sensed object and the sensor magnet is greater than the spacing between the sensed object and the helper magnet. This provides greater freedom in the positioning of the magnets and providing space between the magnets in which the sensed object is moved. In addition, for a compact design of the sensor system the tolerances no longer play as great a role, since greater spacings are possible than heretofore. The spacing between the sensor magnet and the surface of the sensed object may preferably be as great as 20 mm, which clearly demonstrates that the helper magnet provided according to the invention results in a considerable increase in the effective region.

In one refinement of the invention the sensor system is designed for detecting rotational or linear movements of the sensed object. Use of the helper magnet according to the invention thus provides a sensor system for detecting rotational or linear movements that has an expanded functional region compared to known sensor systems.

In one refinement of the invention, the sensor magnet and/or the helper magnet are designed as permanent magnets or electromagnets. This provides freedom in the design of the sensor system, thus allowing the desired effects to be achieved with these types of magnets. The permanent magnet has the advantage that it generates magnetic field lines without the need for an additional power supply. The electromagnet has the advantage that its magnetic field strength and the resulting magnetic field lines may be set very accurately and precisely by means of its power supply.

In a further embodiment of the invention, the sensor magnet and/or the helper magnet are made of a magnetizable plastic. This has the advantage that these magnets may be provided in the exact desired shape for which installation space is available. The magnets may therefore have any given shape, and may be adapted to the geometric proportions on or in the installation space. It is also possible to produce a magnet made of a magnetizable plastic during manufacture of the sensor system.

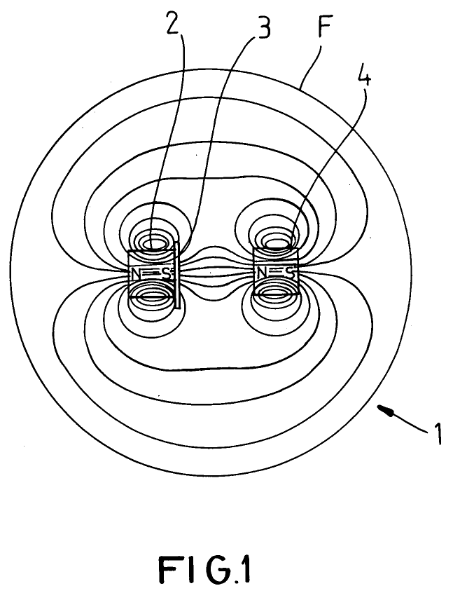

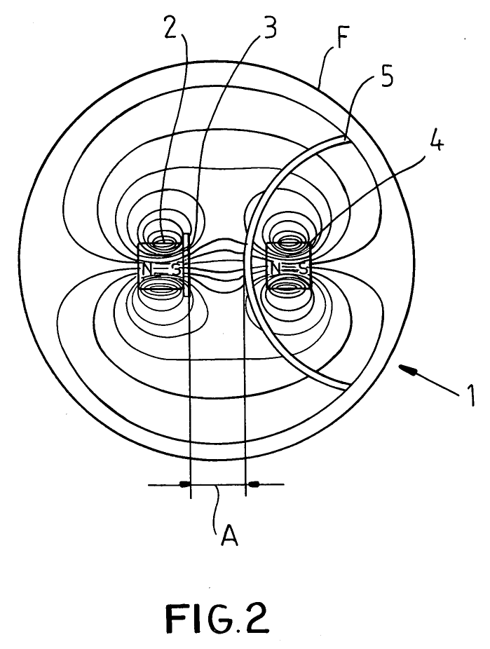

Embodiments of a sensor system according to the invention are illustrated in FIGS. 1 and 2.

The two figures show in detail a sensor system denoted by reference numeral 1, comprising a sensor magnet 2 and an associated magnetosensitive sensor 3, for example a Hall sensor. According to the invention an additional magnet 4, referred to here as a helper magnet, is associated with the sensor magnet 2, the additional magnet 4 resulting in the effect that the magnetic field lines F are concentrated more strongly in the desired direction (preferred direction). In this illustrated embodiment, the preferred direction is shown between the south pole S of the sensor magnet 2 and the north pole N of the additional magnet 4. Other configurations are possible. The sensed object that is movable between the two magnets 2 and 4 is not illustrated in FIG. 1. FIG. 2 illustrates a design of the sensor system 1 for use as a rotational speed sensor. In this case the sensed object (target) is denoted by reference numeral 5. It is also shown that the sensed object 5 is located at a greater spacing A from the sensor magnet 2 than from the magnet 4. Although the working gap for a sensor system 1 according to the prior art (see FIG. 3) is only 5 mm maximum, a spacing as great as 20 mm is possible by use of the magnet 4 according to the invention. The shape of the sensed object 5 as illustrated in FIG. 2 is only an example, and may be adapted to the particular circumstances. Thus, the sensed object 5 may be straight, for example, when the sensor system 1 is designed and used for detecting linear movements.

The sensor magnet 2 and its associated magnetosensitive sensor 3 (sensor element, optionally with an additional field concentrator, for example in the form of a flux guiding plate) are basically fixed in place, whereas the sensed object 5 is movable relative thereto. The helper magnet 4 is likewise fixed in place. The sensed object 5 and the helper magnet 4 may also form a modular unit that is designed for placement at the required spacing from the sensor magnet 2, the helper magnet 4 being securely fixed in this modular unit (and therefore also securely fixed relative to the sensor magnet 2), whereas the sensed object 5 is movable (linearly or rotationally) inside this modular unit.

### LIST OF REFERENCE NUMERALS

1. Sensor system

2. Sensor magnet

3. Magnetosensitive sensor

4. Helper magnet

5. Sensed object

A Spacing

F Field lines

N North pole

S South pole

1. A sensor system having a sensor magnet and a magnetosensitive sensor associated therewith, a sensed object being located and movable near the magnetosensitive sensor wherein an additional magnet is spaced from the sensor magnet and the sensed object is movably positioned between the two magnets.

2. The sensor system according to claim 1 wherein the sensed object is at a greater spacing from the sensor magnet than from the additional magnet.

3. The sensor system according to claim 1 wherein the sensor system is set up to detect rotational or straight-line movement of the sensed object.

4. The sensor system according to claim 1 wherein the sensor magnet or the additional magnet is a permanent magnet or an electromagnet.

5. The sensor system according to claim 1 wherein the sensor magnet and/or the additional magnet is comprised of a magnetizable plastic.

6. The sensor system according to claim 1 wherein the spacing between the sensor magnet and the sensed object is greater than 5 mm and smaller than or equal to 20 mm.
